(19) United States
(12) Patent Application Publication
(10) Pub. No.: US 2013/0159659 A1
(43) Pub. Date: Jun. 20, 2013

(54) MULTI-LEVEL DATA PARTITIONING

(71) Applicants: Boris Gelman, Palo Alto, CA (US); Hualin Wang, San Jose, CA (US); Daniel Baeumges, Viersen (DE); Lars Fricke, Worms (DE); Christian Bensberg, Heidelberg (DE)

(72) Inventors: Boris Gelman, Palo Alto, CA (US); Hualin Wang, San Jose, CA (US); Daniel Baeumges, Viersen (DE); Lars Fricke, Worms (DE); Christian Bensberg, Heidelberg (DE)

(21) Appl. No.: 13/330,584

(22) Filed: Dec. 19, 2011

(51) Int. Cl. G06F 12/00

(52) U.S. Cl. 711/173; 711/E12.001

(57) ABSTRACT

Based on one or more first columns of a table partitioned at a first level over multiple first level partitions, a first partition criteria is evaluated for a data record. Each of the at least first level partitions is further partitioned into a same number of second-level partitions using a same second partitioning method for all first level partitions. One first level partition is identified for storage of the data record, for example by determining the one of the at least two data server processes using the first partition criteria and a first partitioning method that differs from the second partitioning method. Based on one or more second columns of the table, a second partition criteria is evaluated for the data record, and the data record is stored in one of the second-level partitions of the at least two first level partitions.

### TECHNICAL FIELD

The subject matter described herein relates to partitioning of at least one of data storage and data processing demands, for example between more than one server in a multi-server, parallel processing database management system.

### BACKGROUND

In recent years, central processing units (CPUs) of computer processing hardware have generally experienced their greatest performance increases by increasing the number of processor cores rather than through increasing clock rates. Accordingly, to maximize performance, modern software advantageously employs the benefits of multi-core CPUs by allowing parallel execution and with architectures that scale well with the number of cores. For data management systems, taking full advantage of parallel processing capabilities generally requires partitioning of stored data into sections or “partitions” for which the calculations can be executed in parallel.

A database program or database management system generally displays data as two-dimensional tables, of columns and rows. However, data are typically stored as one-dimensional strings. A row-based store typically serializes the values in a row together, then the values in the next row, and so on, while a column-based store serializes the values of a column together, then the values of the next column, and so on.

In general, column-based systems are more efficient when an aggregate needs to be computed over many rows but only for a notably smaller subset of all columns of data, because reading that smaller subset of data can be faster than reading all data. Column-based systems can be more efficient when new values of a column are supplied for all rows at once, because that column data can be written efficiently and replace old column data without touching any other columns for the rows. Row-based systems can be more efficient when many columns of a single row are required at the same time, and when row-size is relatively small, as the entire row can be retrieved with a single disk seek. Row-based systems can also be more efficient when writing a new row if all of the column data is supplied at the same time, as the entire row can be written with a single disk seek.

Column-based storage can facilitate execution of operations in parallel using multiple processor cores. In a column store, data are already vertically partitioned, so operations on different columns can readily be processed in parallel. If multiple columns need to be searched or aggregated, each of these operations can be assigned to a different processor core. In addition, operations on one column can be parallelized by partitioning the column into multiple sections that are processed by different processor cores. Column data is typically of uniform type, which can facilitate opportunities for storage size optimizations available in column-based data stores that are not available in row-based data stores. For example, some modern compression schemes can make use of the similarity of adjacent data to compress. To improve compression of column-based data, typical approaches involve sorting the rows. For example, using bitmap indexes, sorting can often improve compression by approximately an order of magnitude. In conventional systems, columnar compression generally achieves a reduction in storage space requirements at the expense of efficiency of retrieval. Retrieving all data from a single row can be more efficient when that data is located in a single location, such as in a row-based architecture. Further, the greater adjacent compression achieved, the more difficult random-access may become, as data typically need to be uncompressed to be read. Therefore, conventional column-based architectures are often enriched by additional mechanisms aimed at minimizing the need for access to compressed data. These additional mechanisms can result in lower compression efficiency and/or increased processing requirements to access the compressed data.

Currently available relational database management systems can accomplish partitioning based on specified criteria applied to split the database. In general, a partitioning key is used to assign a partition based on certain criteria. Commonly used approaches include range partitioning, list partitioning, hash partitioning, round robin partitioning, and composite partitioning. In range partitioning, a partition can be defined by determining if the partitioning key is inside a certain range. For example, a partition can be created to include for all rows in which values in a column of postal codes are between 70000 and 79999. In list partitioning, a partition can be assigned a list of values and the partition can be chosen if the partitioning key has one of the values on the list. For example, a partition built to include data relating to Nordic countries can includes all rows in which a column of country names includes the text string values Iceland, Norway, Sweden, Finland, Denmark, etc. In hash partitioning, the value of a hash function can determine membership in a partition. For example, for a partitioning scheme in which there are four partitions, the hash function can return a value from 0 to 3 to designate one of the four partitions. Round robin partitioning can be used to distribute storage and/or processing loads among multiple data partitions and/or servers or server processes according to a pre-set rotation among the available partitions or servers or server processes. As an example, a first data unit can be directed to a first partition of three partitions, a second data unit to the second partition, a third data unit to the third partition, a fourth data unit to the first partition, and so forth. In composite partitioning, certain combinations of other partitioning schemes can be allowed, for example by first applying a range partitioning and then a hash partitioning.

### SUMMARY

In one aspect, a method includes evaluating, based on one or more first values of a data record in each of one or more first columns of a table, a first partition criteria for the data record. The table is partitioned at a first level into at least two first level partitions, each of which is further partitioned into a same number of second-level partitions using a second partitioning method that is the same for all of the at least two first level partitions. One of the at least two first level partitions is identified for storage of the data record, at least in part by determining the one of the at least two first level partitions using the first partition criteria and a first partitioning method that differs from the second partitioning method. Based on one or more second values of the data record in each of one or more second columns of the table, a second partition criteria is evaluated for the data record. The data record is stored in one of the plurality of second-level partitions of one of the at least two first level data partitions. The one of the plurality of second-level partitions is selected based on the second partition criteria according to the second partitioning method.

In some variations or the current subject matter, one or more of the following features can optionally be included in any feasible combination. The first partitioning method can optionally include hash partitioning, and the first partition criteria can optionally include a hash value calculated based on the one or more first values in the one or more columns of the table. The hash value can optionally include one of a set of hash values that contains one hash value for each of the at least two first level partitions. The second partitioning method can optionally include range partitioning, and the second partition criteria can optionally include range values assigned to each of the plurality of second level partitions. The range values for the one of the at least two data server processes can optionally be identical to those for each of the at least two first level partitions. The one or more first columns can optionally include a primary key column for the table. Each of the at least two first level partitions can optionally be hosted on a different one of at least two data server processes.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating features of a partitioning approach consistent with at least some implementations of the current subject matter;

FIG. 2 is a process flow diagram illustrating aspects of a method having one or more features consistent with at least some implementations of the current subject matter;

FIG. 3 is a diagram illustrating features of a business software system architecture consistent with at least some implementations of the current subject matter;

FIG. 4 is a diagram illustrating features of a database management system architecture consistent with at least some implementations of the current subject matter;

FIG. 5 is a diagram illustrating features of another database management system architecture consistent with at least some implementations of the current subject matter; and

FIG. 6 is a diagram illustrating features of a multi-tenancy database structure consistent with at least some implementations of the current subject matter.

When practical, similar reference numbers denote similar structures, features, or elements.

### DETAILED DESCRIPTION

One or more implementations of the current subject matter can, among other possible advantages, provide a multi-level partitioning approach for use in a database management system. In some implementations, time-based (or other range-based) partitions can be used such that a current partition is capable of being merged and/or compressed with one or more partitions containing older data. In at least some implementations, a partitioning attribute that is distinct from a key value attribute of data records in the data records being partitioned can be used. A multi-level partitioning approach consistent with implementations described herein can optionally be applied to perform load balancing between multiple parallel servers or server processes and to further sub-partition data storage on these multiple parallel servers or server processes. Alternatively or in addition, a multi-level partitioning approach such as described herein can be applied in a single server or server process to provide a larger number of partitions with improved parallelism.

In a stack partitioning approach, two branches of a partition tree of a table, column, database, etc. can have different structures. In one example, at a first level of a partitioning tree, a first partitioning of a database or table can be performed using hash partitioning and a second partition can be split using a range partition. Additionally, even if the same partitioning scheme is used at each branch or partitioning level, differing criteria can be used for the partitioning of each branch or level. For example, a first branch can use hash partitioning with a hash value of 4 (creating sub-partitions numbered 0, 1, 2, and 3) while a second branch can use hash partitioning with a hash value of 2 (creating sub-partitions numbered 4 and 5). Other partitioning approaches, for example round robin partitioning, do not assign data to partitions according to any structure that can improve the speed with which data can be retrieved.

As noted above, allowing differing partitioning approaches at equivalent sub-levels of a partitioning tree leads to non-uniformity among branches of the partitioning tree. In contrast, in a multi-level partitioning approach consistent with one or more implementations of the current subject matter, each sub-level of any partition is identical to the same sub-level of the other partitions. This feature can provide one or more benefits. For example, data pruning, which can, for example, include removal or invalidation of old data from a database, can be more readily accomplished. In an advantageous implementation, each server or data server process can include the same partitioned data range in the same location within a partition tree, which can simplify and speed access to the data.

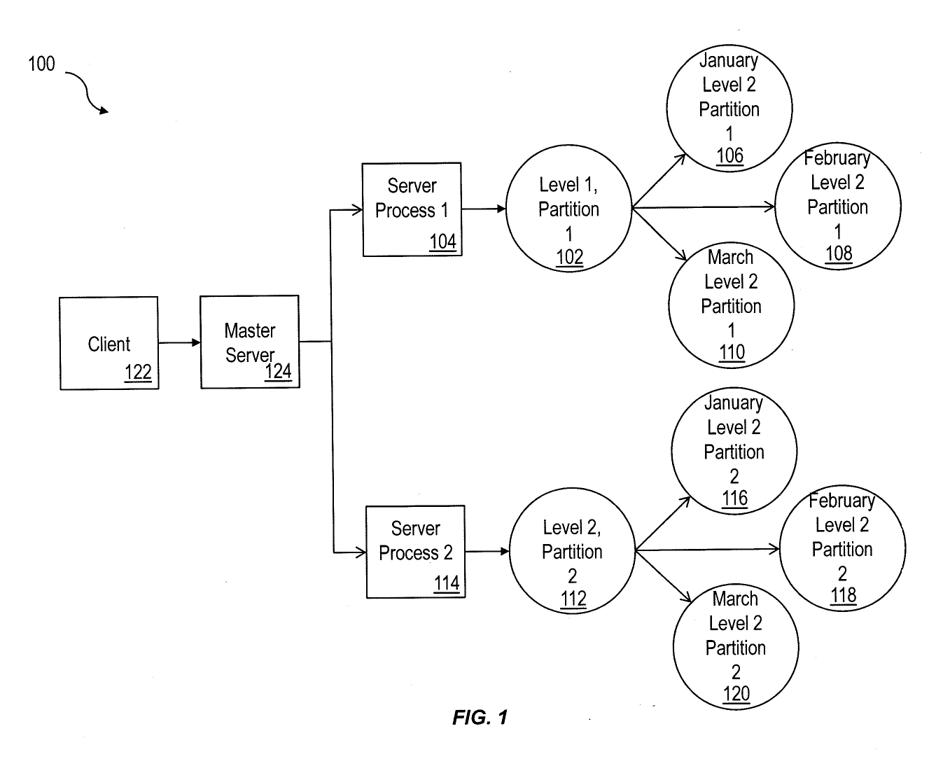

In one implementation of the current subject matter, a multi-level partitioning approach can be used in conjunction with data that are amenable to being range partitioned (e.g. related by a temporal attribute, such as age of a data record, date of origin or most recent modification of a data record, etc., or by some other value capable of being binned or grouped into two or more ranges). In one non-limiting example illustrated in FIG. 1, range partitioning according to months can be used to divide data records among multiple partitions on each of several parallel servers or data server processes. As shown in the framework 100 of FIG. 1, a database can be range partitioned into one partition for each month of the first quarter of a year. Accordingly, a level 1 first data partition 102 on a first data process server 104 is sub-partitioned into a level 2 first January partition 106, a level 2 first February partition, 108, and a level 2 first March partition 110. A level 1 second data partition 112 on a second data process server 114 is sub-partitioned into a level 2 second January partition 116, a level 2 second February partition, 118, and a level 2 second March partition 120.

In the example illustrated in FIG. 1, the partitioning of data on the database between the level 1 first database partition 102 and the level 1 second database partition 112 can be accomplished using a hash partitioning approach in which a hash value is calculated for a data record using a hash function based on values for the data record in one or more columns of the database. FIG. 1 shows two server processes 104, 114 respectively hosting the two level 1 partitions 102, 112, but this simplified depiction is not intended as a limitation. Any number of parallel server processes with associated level 1 data partitions is within the scope of the current subject matter. Additionally, the first level partitioning need not be between two or more server processes but can instead be performed within a single server process.

FIG. 1 also shows a client 122 communicating with a master server 124 that can direct data requests and queries as well as new data to be stored to the appropriate one of the two or more level 1 data partitions 102, 112 on the two or more server processes 104, 114. In some implementations, the master server 124 can perform the calculation of the hash function to determine the hash value that dictates which of the server processes 104, 114 receives new data and where to find new data in response to a query or request. In other implementations consistent with aspects of the current subject matter, the client 122 can perform one or more of the above-noted functions of the master server 124 and can optionally eliminate the need for a separate master server 124 in distributing and maintaining data across two or more parallel server processes 104, 114. In still other implementations, the master server can be considered as a passive resource, for example a repository storing metadata or other data, rules, attributes, criteria, etc. that can be called by one or more or all of a standalone master server machine or machines, one or more index servers that can be co-located with one of the server processes 104, 114, the client 122, etc.

In addition, while the approach depicted in FIG. 1 employs hash partitioning to distribute data among the parallel server processes 104, 114 and range partitioning to further distribute data from each of the two or more level 1 partitions 102, 112 into second level partitions (e.g. sub-partitions), implementations using these or other partitioning approaches or other partitioning approaches (e.g. round robin partitioning) in a different order are also within the scope of the current subject matter. For example, range partitioning (or some other partitioning approach) can be used at the first level to distribute data among two or more parallel server processes, and hash partitioning (or some other partitioning approach different than the partitioning approach used at the first level) can be used at the second level. Range partitioning can be applied on any data that are amenable to being orders (e.g. postal codes, dates, phone numbers, catalog numbers etc.). The use of date values in range partitioning as discussed herein can be particularly advantageous in certain applications in which the date itself is a query value provided within a query of the database. In this case, the query itself can designate which level 2 partition needs to be searched to reply to the query. In still other implementations, multi-level partitioning can be performed within a single server process or physical server. In this manner, a multi-level partitioning tree structure can create multiple sub-partitions of the data storage with improved parallelism that can improve the efficiency of database operations such as indexing, merging, pruning, data retrieval, and the like.

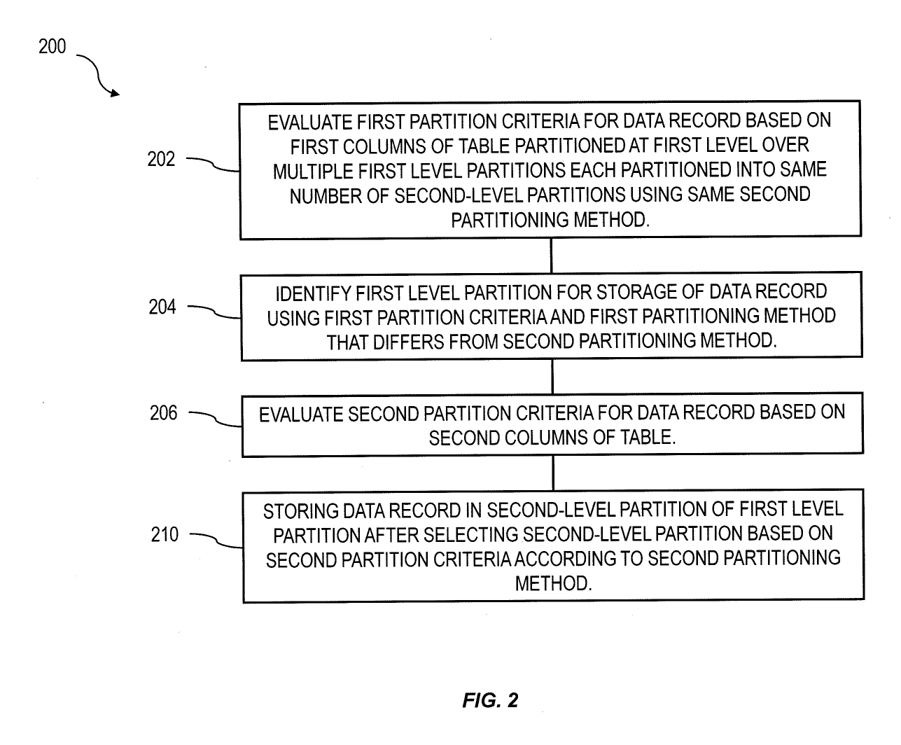

FIG. 2 shows a process flow chart 200 illustrating method features, one or more of which can be included in implementations of the current subject matter. At 202, one or more first partition criteria are evaluated for a data record in a table managed by a database management system. The table can include all or part of a database partitioned by the database management system over at least two first level data partitions. In an optional implementation, the at least two first level data partitions can be assigned to at least two server processes, which can optionally be virtual machines (e.g. virtual hosts) implemented on one or more physical processors; standalone, separate physical machines, each including at least one physical processor, or a combination of virtual machines and physical machines. The evaluation of the first partition criteria can include evaluation of a first value of the data record in each of one or more first columns of the table. Each of the at least two first level data partitions is further partitioned into a same number of second-level partitions using a second partitioning method that is the same for all of the at least two first level data partitions. At 204, one of the at least two first level data partitions is identified for storage of the data record. The identifying includes determining the one of the at least two first level data partitions using the first partition criteria and a first partitioning method that differs from the second partitioning method. The first and the second partition strategy can each include one of hash partitioning, range partitioning, round robin partitioning, or the like. Based on a second value of the data record in each of one or more second columns of the table, at 206 one or more second partition criteria are evaluated for the data record. The data record is stored at 210 in one of a plurality of second-level partitions of one of the at least two first level data partitions. The one of the plurality of second-level partitions is selected based on the second partition criteria according to a second partitioning method.

Use of hash partitioning as the first partitioning method for the first level partitioning and range partitioning as the second partitioning method for the second level partitioning can be advantageous in enabling time-based partitioning without requiring that older data be frequently merged or compressed with newer data. In a conventional approach, data loaded into a table must eventually be merged into a main index. The timing of such a merge is typically based on the size of the main index. By partitioning at the second level according to a temporal range (e.g. month, week, year, or some other period of time), more recent (and therefore generally more frequently accessed) data records are kept together while older data records remain in partitions that do not need to be accessed (and therefore re-indexed and/or decompressed and re-compressed) as frequently.

Using hash partitioning, for example as the first partitioning method for the first level partition between the data sever processes, one or more columns containing line item numbers or some other key value that includes substantial variation among data records (varies a lot) can be chosen as the hash column. A hash value can be calculated based on the data record values in each of one or more columns using a hash function. If multiple columns are used, the hash function can include concatenation of the data record values in the multiple columns. The first partitioning method can optionally include round robin partitioning, range partitioning, or some other form or partitioning in other implementations.

The second partitioning approach, which can optionally include range partitioning (or can optionally include hash partitioning, round robin partitioning, or some other form of partitioning), can include evaluation of a second partitioning criteria based on one or more second columns, which do not include the one or more first columns used in evaluation of the first partitioning criteria. As such, while the first partitioning criteria can include a primary key value for the data record, the second partitioning criteria does not.

In further variations, an additional partitioning level can be used in addition to the level 1 and level 2 partitioning levels discussed above. For example, an additional layer can include an additional hash partitioning level. In some implementations, a third partitioning layer can be used, for example in place of history tables used to track changes to the database or one or more tables in the database.

Implementations of the current subject matter can provide one or more advantages. For example, load distribution among multiple servers or server processes can be accomplished while also reducing or minimizing data merge loads. Distribution of data among multiple servers or server processes can in some implementations be accomplished using a first partitioning approach while the partition assignment per server is determined by a second partitioning approach. In some implementations, the first partitioning approach can be designed to maximize load balancing, for example by generating a hash value with equal distribution among the available servers or server processes or, alternatively, by using a round robin partitioning approach. The second partitioning approach can provide unequal load distribution among multiple partitions on a given server or serve process, but can facilitate retrieval of data with lower latency due to its non-random distribution among the second level partitions on a given server. Scanning of fewer indexes is required, which can lead to improved performance.

Additionally, if partitioning by date ranges is used for the second level partitions, writing of older partitions (e.g. partitions with older records, such as form previous months, etc.) can be avoided or reduced. In one illustrative example, partition pruning can be used to determine the relevant month, for example according to what is specified in a SQL “where” cause or its analog in other database management languages. Handling of delta merges can also be improved, for example because the timing of a delta merge is generally based on the size of a main index. By partitioning at the second partitioning level according to a set time period (e.g. months), an upper limit on the required merge time can be imposed because only data relevant to that set time period needs to be merged.

When data records are inserted into a table or a database, a primary key check is generally required to ensure that duplication of a primary key does not occur. Implementations of the current subject matter, for example those using hash partitioning at the first level and range partitioning at the second level, can require that the primary check be performed only at the second level. For example, the hash partitioning, which uses at least the primary key, designates the server or server process of the multiple servers or server processes to which the data record should be directed. The primary key must then only be checked against the data on the designated server or server process for insertion of the data record. The second-level partitioning allows the use of non-key columns. For example, a date is not always part of the primary key.

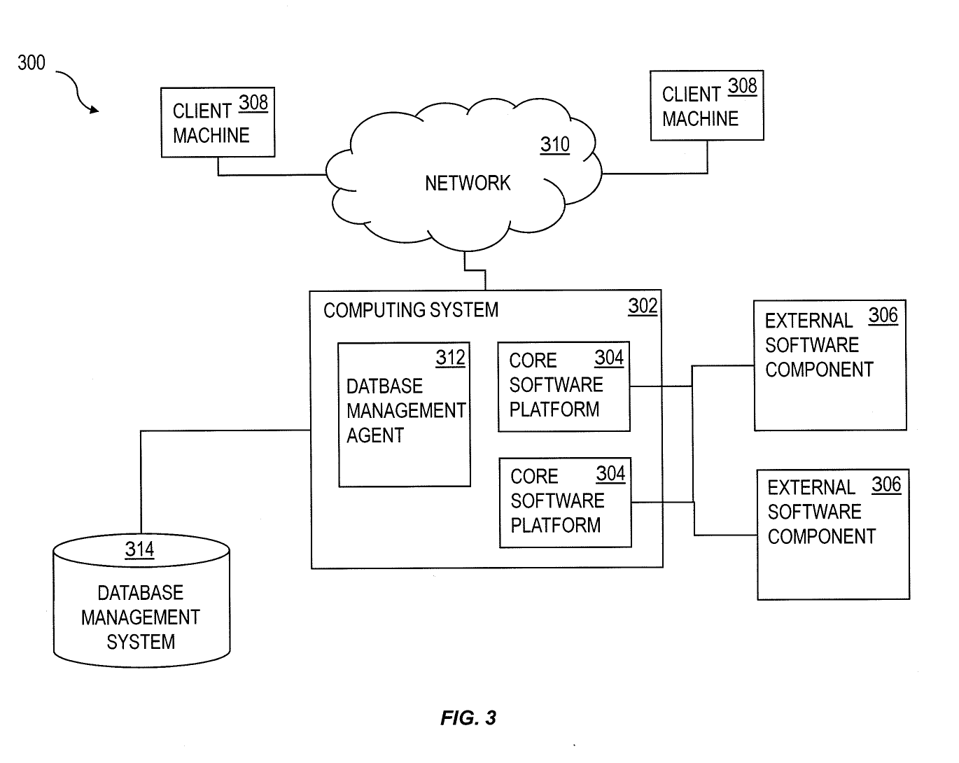

Consistent with some implementations of the current subject matter, the core software platform of an enterprise resource planning (ERP) system, other business software architecture, or other data-intensive computing application or software architecture can be provided as a standalone, customized software installation that runs on one or more processors that are under the control of a specific organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 3 shows a diagram of a system consistent with such an implementation. A computing system 302 can include one or more core software platform modules 304 providing one or more features of the business software system. The computing system can also aggregate or otherwise provide a gateway via which users can access functionality provided by one or more external software components 306. Client machines 308 can access the computing system, either via a direct connection, a local terminal, or over a network 310 (e.g. a local area network, a wide area network, a wireless network, the Internet, or the like).

A data management agent 312 or other comparable functionality can access a database management system 314 that stores and provides access to data (e.g. definitions of business scenarios, business processes, and one or more business configurations as well as data, metadata, master data, etc. relating to definitions of the business scenarios, business processes, and one or more business configurations, and/or concrete instances of data objects and/or business objects that are relevant to a specific instance of a business scenario or a business process, and the like. The database management system 314 can include parallelization features consistent with those described herein.

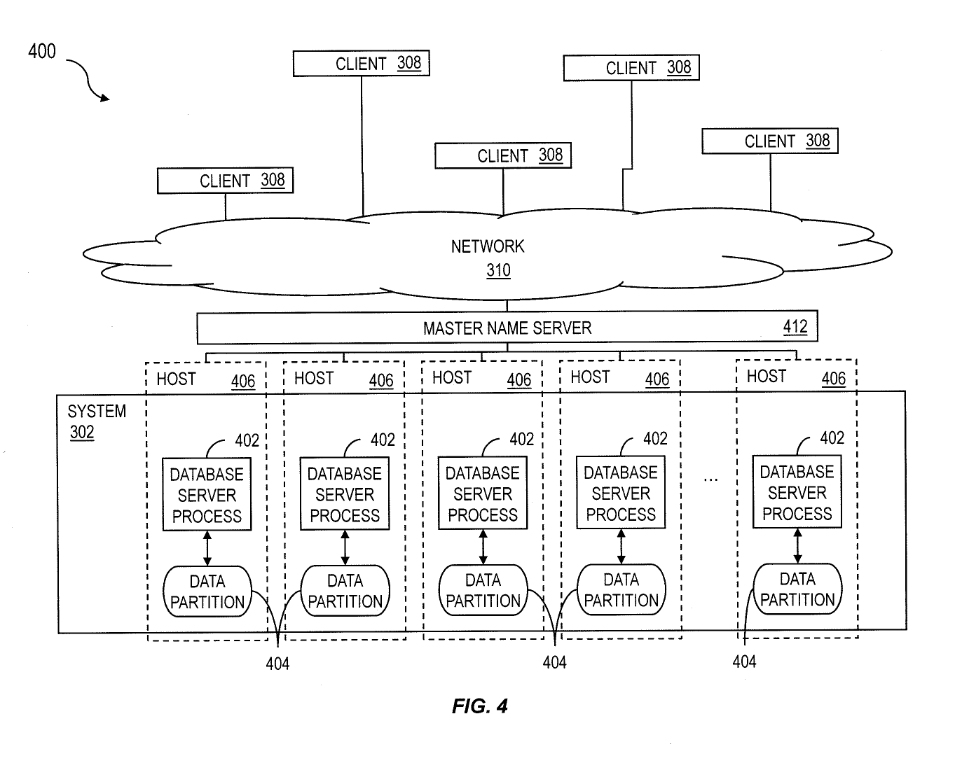

For data distribution purposes, tables or ranges within tables can be assigned to different database partitions that are assigned to different hosts, for example for scalability reasons. FIG. 4 shows an example of an enterprise resource system architecture 400 consistent with an implementation that includes data distribution for scalability reasons. Such a configuration can be used for large, on-premise or stand-alone systems with high performance requirements. Each data server process 402 and its associated data partition 404 can be assigned to a discrete host 406. A host 406 can be a standalone machine with one or more physical processors or a virtual machine on a larger system 302 as depicted in FIG. 4. A central component, labeled as a name server 412 in FIG. 4, knows the topology of the system and how data is distributed. In a system with data distribution, the name server knows which tables or partitions of tables are located on which data server process 402. One or more clients 414 (e.g. client machines 308) can access the name server 412, either via a direct connection or over a network 416.

In a data distribution scenario, the partitioning can be done table wise or also by splitting tables. With table wise partitioning, the name server assigns new tables to a database server process 402 based on the current distribution of tables (number of tables assigned to each database server process 402). Then data for this table will reside only on that database server process 402. It is also possible to specify that a table is split over multiple database server processes 402. The name server 412 can optionally partition the table based on a size estimation specified by the application. When records are inserted into a split table, the records can be distributed to other database server processes 402 based on name server information.

Smaller organizations can also benefit from use of business software functionality. However, such an organization may lack the necessary hardware resources, IT support, and/or consulting budget necessary to make use of a standalone business software software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

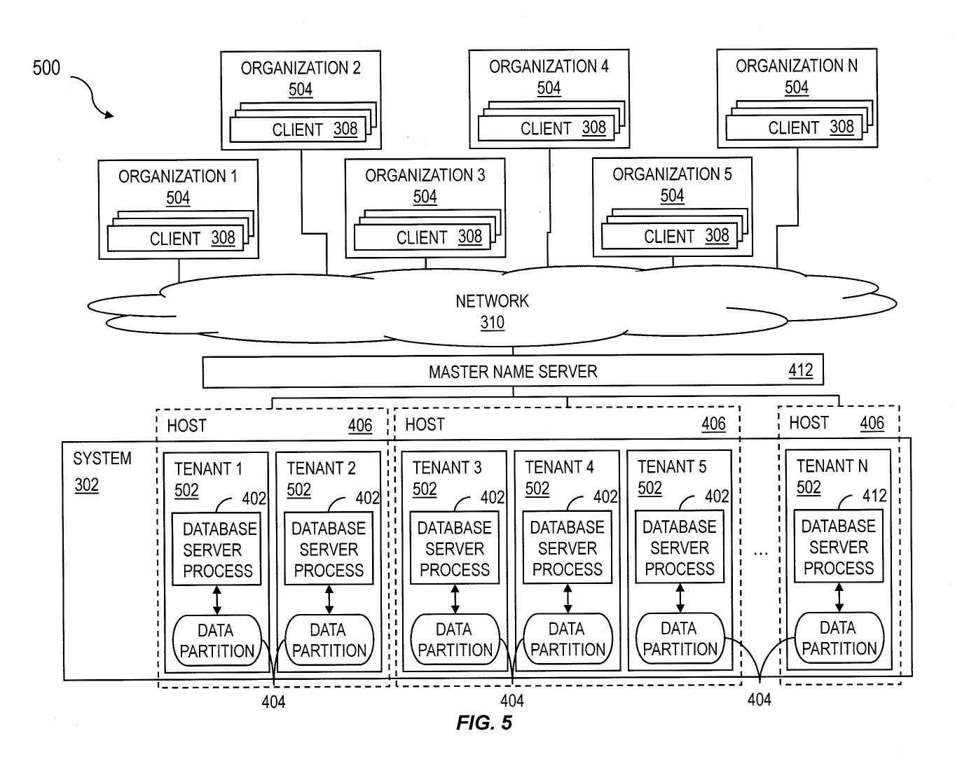

Data partitioning consistent with implementations of the current subject matter can also be used in a multi-tenancy environment as illustrated in the system architecture 500 of FIG. 5. Multiple tenants 502, each isolated from one another and available to be accessed by clients 414 within a separate organization 504 of a plurality of organizations via a network 416, can be hosted by a same host 406, which can be a virtual machine on a larger system 302 as shown in FIG. 5 or a separate system that includes one or more physical processors. Tenants 502 can also optionally be distributed across multiple database server processes 402 on more than one host 406. In this manner, tables or ranges within tables are assigned to different database server processes 402 that are assigned to different hosts 406 for scalability reasons. One or more tenants 502 can alternatively be served by a single database server process 402 accessing a data partition 404 (or multiple data partitions 404) for the respective tenant 502 that is isolated from other tenants 502.

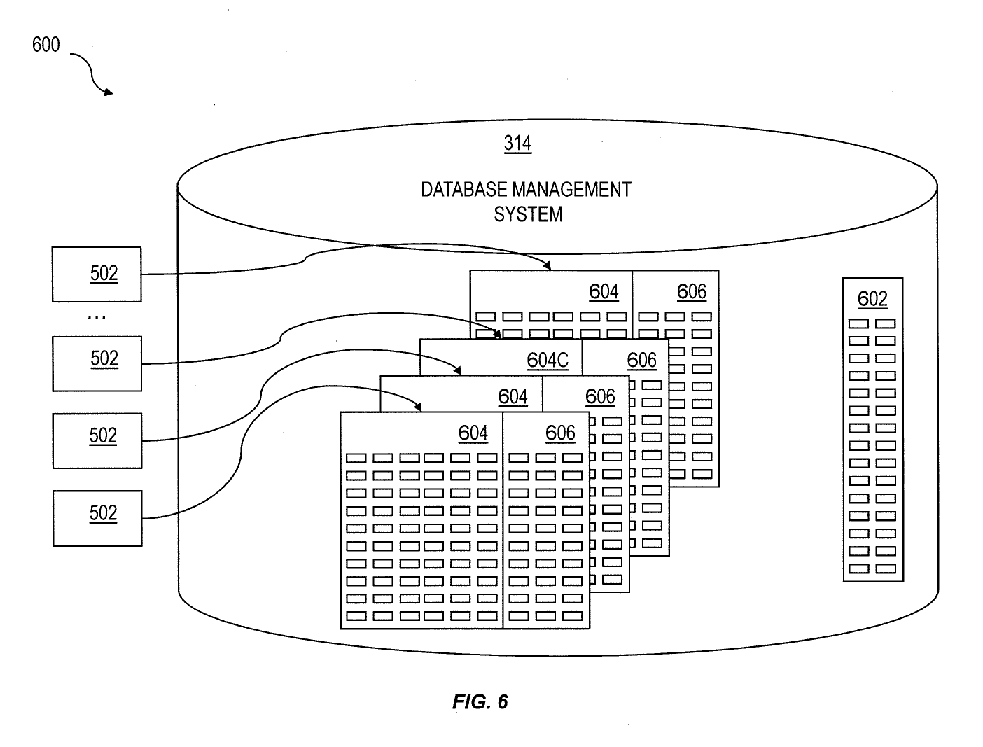

To provide for customization of the business process for each of multiple organizations supported by a single software delivery architecture 500, the data and data objects stored by a database management system 314 can include three types of content as shown in FIG. 6: core software platform content 602 (e.g. a standard definition of a business process), system content 604, and tenant content 606. Core software platform content 602 includes content that represents core functionality and is not modifiable by a tenant. System content 604 can in some examples be created by the runtime of the core software platform and can include core data objects that store concrete data associated with specific instances of a given business process and that are modifiable with data provided by each tenant. The data retained in these data objects are tenant-specific: for example, each tenant 502 of the group of tenants can store information about its own inventory, sales order, etc. Tenant content 606 for isolated to each tenant 502 of the group of tenants includes data objects or extensions to other data objects that are customized for one specific tenant 502 of the group of tenants to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 606 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 602 and system content 604 and tenant content 606 of a specific tenant 502 of the group of tenants are accessed to provide the business process definition and/or the status information relating to a specific instance of the business process according to customizations and business data of that tenant such that each tenant 502 of the group of tenants is provided access to a customized solution whose data are available only to users from that tenant 502.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
evaluating, based on one or more first values of a data record in each of one or more first columns of a table, a first partition criteria for the data record, the table being partitioned at a first level into at least two first level partitions, each of the at least two first level partitions being further partitioned into a same number of second-level partitions using a second partitioning method that is the same for all of the at least two first level partitions;
identifying one of the at least two first level partitions for storage of the data record, the identifying comprising determining the one of the at least two first level partitions using the first partition criteria and a first partitioning method that differs from the second partitioning method;
evaluating, based on one or more second values of the data record in each of one or more second columns of the table, a second partition criteria for the data record; and
storing the data record in one of the plurality of second-level partitions of one of the at least two first level data partitions, the one of the plurality of second-level partitions being selected based on the second partition criteria according to the second partitioning method.

2. A computer program product as in claim 1, wherein the first partitioning method comprises hash partitioning, and the first partition criteria comprises a hash value calculated based on the one or more first values in the one or more columns of the table.

3. A computer program product as in claim 2, wherein the hash value comprises one of a set of hash values that contains one hash value for each of the at least two first level partitions.

4. A computer program product as in claim 1, wherein the second partitioning method comprises range partitioning, and the second partition criteria comprises range values assigned to each of the plurality of second level partitions.

5. A computer program product as in claim 3, wherein the range values for the one of the at least two data server processes are identical to those for each of the at least two first level partitions.

6. A computer program product as in claim 1, wherein the one or more first columns comprises a primary key column for the table.

7. A computer program as in claim 1, wherein each of the at least two first level partitions is hosted on a different one of at least two data server processes.

8. A system comprising:
at least one programmable processor; and
a machine-readable medium storing instructions that, when executed by the at least one processor, cause the at least one programmable processor to perform operations comprising:
evaluating, based on one or more first values of a data record in each of one or more first columns of a table, a first partition criteria for the data record, the table being partitioned at a first level into at least two first level partitions, each of the at least two first level partitions being further partitioned into a same number of second-level partitions using a second partitioning method that is the same for all of the at least two first level partitions;
identifying one of the at least two first level partitions for storage of the data record, the identifying comprising determining the one of the at least two first level partitions using the first partition criteria and a first partitioning method that differs from the second partitioning method;
evaluating, based on one or more second values of the data record in each of one or more second columns of the table, a second partition criteria for the data record; and
storing the data record in one of the plurality of second-level partitions of one of the at least two first level data partitions, the one of the plurality of second-level partitions being selected based on the second partition criteria according to the second partitioning method.

9. A system as in claim 8, wherein the first partitioning method comprises hash partitioning, and the first partition criteria comprises a hash value calculated based on the one or more first values in the one or more columns of the table.

10. A system as in claim 9, wherein the hash value comprises one of a set of hash values that contains one hash value for each of the at least two data server processes.

11. A system as in claim 8, wherein the second partitioning method comprises range partitioning, and the second partition criteria comprises range values assigned to each of the plurality of second level partitions.

12. A system as in claim 11, wherein the range values for the one of the at least two data server processes are identical to those for each of the at least two data server processes.

13. A system as in claim 8, wherein the one or more first columns comprises a primary key column for the table.

14. A computer-implemented method comprising:
evaluating, based on one or more first values of a data record in each of one or more first columns of a table, a first partition criteria for the data record, the table being partitioned at a first level into at least two first level partitions, each of the at least two first level partitions being further partitioned into a same number of second-level partitions using a second partitioning method that is the same for all of the at least two first level partitions;
identifying one of the at least two first level partitions for storage of the data record, the identifying comprising determining the one of the at least two first level partitions using the first partition criteria and a first partitioning method that differs from the second partitioning method;
evaluating, based on one or more second values of the data record in each of one or more second columns of the table, a second partition criteria for the data record; and
storing the data record in one of the plurality of second-level partitions of one of the at least two first level data partitions, the one of the plurality of second-level partitions being selected based on the second partition criteria according to the second partitioning method.

15. A computer-implemented method as in claim 14, wherein the first partitioning method comprises hash partitioning, and the first partition criteria comprises a hash value calculated based on the one or more first values in the one or more columns of the table.

16. A computer-implemented method as in claim 15, wherein the hash value comprises one of a set of hash values that contains one hash value for each of the at least two data server processes.

17. A computer-implemented method as in claim 14, wherein the second partitioning method comprises range partitioning, and the second partition criteria comprises range values assigned to each of the plurality of second level partitions.

18. A computer-implemented method as in claim 17, wherein the range values for the one of the at least two data server processes are identical to those for each of the at least two data server processes.

19. A computer-implemented method as in claim 14, wherein the one or more first columns comprises a primary key column for the table.

20. A computer-implemented method as in claim 14, wherein at least one of the evaluating of the first partition criteria for the data record, the assigning one of the at least two data server processes for storage of the data record, the evaluating of the second partition criteria for the data record, and the storing of the data record in one of the plurality of second-level partitions controlled by the one of the at least two data server processes are performed by at least one programmable processor.
